(19) United States
(12) Patent Application Publication
(10) Pub. No.: US 2013/0105565 A1
(43) Pub. Date: May 2, 2013

(54) Nutritional Information System

(71) Applicant: Richard Alan Kamprath, Dallas, TX (US)

(72) Inventor: Richard Alan Kamprath, Dallas, TX (US)

(21) Appl. No.: 13/284,872

(22) Filed: Oct. 29, 2011

(51) Int. Cl. G06F 17/40

(52) U.S. Cl. 235/375

(57) ABSTRACT

Software applications for tracking nutritional information, which may be used on a smart phone for example. Product packaging information for a food product may be read and converted to a food product identification for the food product. A comparison of the food product identification against a food product identification database may be used to retrieve food product information for the food product from the database. At least part of the food product information for the food product is added to a user profile. A nutritional profile of the user profile is analyzed based the addition of the food product information for the food product. The user profile is updated with results of the analyzing for tracking nutritional information for the user profile. A user can then monitor food intake (such as fat, calories, sugar, food types), which may be compared to desired targets, goals, or limits.

### TECHNICAL FIELD

The present application generally relates to a nutritional information system, such as a software app for a mobile computing device or smart phone for tracking and recording nutritional information of a user.

### BACKGROUND

There are many software apps currently available for smart phones, for example, which help make the user's life more convenient. More and more, people are becoming more aware of the health benefits and ability to extend their life by eating healthy and/or eating less calories. For some people, it is critical to track and monitor the amount of calories and food types eaten to maintain or lose weight.

There are diet systems that assign points to different food products, but this limits the user to a set of foods that are precoded or predetermined provided by the diet system. There is a need for a nutritional information system that is more flexible and expansive.

Most food products include some amount of nutritional information on the product label. Also, many restaurants make this nutritional information available to customers regarding the food served on their menu. However, most people do not keep track of their calorie intake nor a tally of their consumption of certain food types and parts (e.g., fat, cholesterol, sugar) because it is not convenient or easy to do so. There is a need for a user friendly software system to help a user make more use of this information.

### SUMMARY

The problems and needs outlined above may be addressed by embodiments of the present invention. In one aspect, a software app embodiment for a mobile computing device or smart phone is provided for tracking and recording nutritional information of a user. This can help a user keep track of calorie intake or amounts of certain food types (e.g., vegetables, fruit) eaten, for example.

In accordance with another aspect of the present invention, which will be summarized in this paragraph by describing example embodiments, a non-transitory computer readable medium including at least executable computer program code tangibly stored therein for tracking nutritional information, is provided. The computer readable medium includes: computer program code for receiving a food product identification for a food product; computer program code for comparing the food product identification against a food product identification database; computer program code for retrieving food product information for the food product from the database; computer program code for adding at least part of the food product information for the food product to a user profile; computer program code for analyzing a nutritional profile of the user profile based on the addition of the food product information for the food product; and computer program code for updating the user profile with results of the analyzing for tracking nutritional information for the user profile. The receiving of the food product identification may include receiving an RFID for the food product. The receiving of the food product identification may include receiving a bar code for the food product. The receiving of the food product identification may include receiving a visual image of a code on the food product. The receiving of the food product identification may include receiving a radio frequency signal from an RFID tag on the food product and converting the radio frequency signal to an RFID for the food product. The receiving of the food product identification may include receiving a translated food product code translated by a portable electronic device after the portable electronic device scans an untranslated food product code on the food product. The untranslated food product code may include a barcode. The untranslated food product code may include a radio frequency signal that includes an RFID for the product. The untranslated food product code may include a mosaic of black and white rectangles. The computer readable medium may include computer program code for triggering an alert for the user profile if a selected threshold is exceeded for at least part of the nutritional profile based on the addition of the food product information for the food product. The computer readable medium may include computer program code for transmitting the updated nutritional profile to a portable electronic device via a communication network. The communication network may include the Internet. The communication network may include a cellular telephone communication network. The computer readable medium may include computer program code for displaying the nutritional profile on a portable electronic device. The analyzing of the nutritional profile may include calculating daily nutritional consumption for the user profile based on the retrieved food product information for the food product. The analyzing of the nutritional profile may include comparing the daily nutritional consumption for the user profile to a targeted profile for losing weight. The analyzing of the nutritional profile may include comparing the daily nutritional consumption for the user profile to a targeted profile for gaining weight. The analyzing of the nutritional profile may include comparing the daily nutritional consumption for the user profile to a targeted profile for eating healthy. The analyzing of the nutritional profile may include comparing the daily nutritional consumption for the user profile to a targeted profile for improving cardiovascular health. The analyzing of the nutritional profile may include comparing the daily nutritional consumption for the user profile to a targeted profile for diabetic intake limits. The analyzing of the nutritional profile may include comparing the food product information for the food product to a food allergy profile for the user profile. The computer readable medium may include computer program code for generating an alert for the user profile if a food allergy correlation is found from the analyzing. The computer readable medium may include computer program code for disassociating the food product information previously added to the user profile. The computer readable medium may include computer program code for categorizing the food product information for the food product into a food type group in the user profile. The computer readable medium may include computer program code for generating a delta field value for a certain category of nutritional information, the delta field value being a difference between a calculated value and a threshold value for the certain category of nutritional information based on the addition of the food product information for the food product. The computer readable medium may include computer program code for generating a visual display of the delta field value on a portable electronic device. The computer readable medium may include computer program code for displaying a food product list to a user, computer program code for receiving a selection by the user of the food product from the food product list, and computer program code for converting the selection by the user to the food product identification. The computer readable medium may include computer program code for adding points to a certain data field of the user profile based on the addition of the food product information for the food product. The computer readable medium may include computer program code for assigning points to the food product based on the food product information for the food product. The computer readable medium may include computer program code for adding points to the user profile for the food product. The computer readable medium may include computer program code for receiving an input from a user for a percentage of the food product. The computer readable medium may include computer program code for dividing the percentage by 100 to generate a multiplying factor, and computer program code for multiplying at least one value of the food product information for the food product by the multiplying factor. The computer program code for analyzing may include one or more of the following operations (separate or in combination): summing consumption, finding a mean consumption, finding a mode consumption, finding a median consumption, and finding a total consumption, finding a difference between daily consumption and recommended daily allowance, finding variance, and finding standard deviation.

In accordance with another aspect of the present invention, which will be summarized in this paragraph by describing example embodiments, a software application configured to execute on at least one processor of a portable electronic device when stored in a non-transitory computer readable medium on the portable electronic device, is provided. The software application includes at least executable computer program code for tracking nutritional information, which may include: computer program code for receiving product packaging information for a food product; computer program code for requesting a conversion of the product packaging information to a food product identification for the food product; computer program code for requesting a comparison of the food product identification against a food product identification database; computer program code for retrieving food product information for the food product from the database; computer program code for adding at least part of the food product information for the food product to a user profile; computer program code for analyzing a nutritional profile of the user profile based the addition of the food product information for the food product; and computer program code for updating the user profile with results of the analyzing for tracking nutritional information for the user profile. The conversion of the product packaging information to the food product identification for the food product may be performed by the at least one processor of the portable electronic device. The conversion of the product packaging information to the food product identification for the food product may be performed by a remote computer system after the portable electronic device transmits the product packaging information via a communication network (e.g., cell phone network, wired communication network, WiFi, wireless communication network, Internet, or any combination thereof). The comparison of the food product identification against a food product identification database may be performed by the at least one processor of the portable electronic device. The comparison of the food product identification against a food product identification database may be performed by a remote computer system after the portable electronic device transmits the product packaging information to the remote computer system via a communication network. The comparison of the food product identification against a food product identification database may be performed by a remote computer system after the portable electronic device transmits the food product identification to the remote computer system via a communication network. The retrieving food product information for the food product from the database may be performed by the portable electronic device. The retrieving food product information for the food product from the database may be performed by a remote computer system. The adding at least part of the food product information for the food product to the user profile may be performed by the portable electronic device. The adding at least part of the food product information for the food product to the user profile may be performed by a remote computer system. The analyzing of the nutritional profile of the user profile based the addition of the food product information for the food product may be performed by the portable electronic device. The analyzing of the nutritional profile of the user profile based the addition of the food product information for the food product may be performed by a remote computer system. The updating of the user profile with results of the analyzing for tracking nutritional information for the user profile may be performed by the portable electronic device. The user profile may be updated with results of the analyzing for tracking nutritional information for the user profile by a remote computer system, and the updated user profile may be transmitted from the remote computer system to the portable electronic device via a communication network. The product packaging information may include a barcode. The product packaging information may include a digital photograph of a mosaic of black and white rectangles. The product packaging information may include a digital photograph of the product packaging. The product packaging information may include an RFID embedded in a radio frequency signal emitted from the food product. The computer program code for receiving product packaging information for the food product may include computer program code for generating a food product list on a graphical user interface of the portable device, and computer program code for allowing a user to select an item on the food product list via the graphical user interface. The computer program code for receiving product packaging information for the food product may include providing a text search field for user input via a keyboard.

In accordance with another aspect of the present invention, which will be summarized in this paragraph by describing example embodiments, a computer-implemented method for tracking nutritional information, is provided, which includes: receiving a food product identification for a food product; comparing the food product identification against a food product identification database; retrieving food product information for the food product from the database; adding at least part of the food product information for the food product to a user profile; analyzing a nutritional profile of the user profile based the addition of the food product information for the food product; and updating the user profile with results of the analyzing for tracking nutritional information for the user profile. The method may be performed in a computer system including at least one memory and at least one processor. The receiving of the food product identification may be performed by the computer system via a communication network. The food product identification may have been previously obtained at a remote location with a portable electronic device and transmitted to the computer system by the portable electronic device. The method may include transmitting at least part of the updated user profile to the portable electronic device. The method may include formatting the at least part of the updated user profile in a graphical display format compatible with the portable electronic device prior to the transmitting. The method may be performed in a portable electronic device including at least one memory and at least one processor. The database may stored in the at least one memory of the portable electronic device. The method may include requesting updates for the database via a communication network, and receiving updates for the database via the communication network. At least part of the database may be stored in the at least one memory of the portable electronic device. For example, when the comparing step the food product identification is not found in the at least part of the database stored in the portable electronic device, the method may include sending the food product identification to a remote computer system via a communication network with a request to compare the food product identification with another part of the database at the remote computer system, and receiving at the portable electronic device the retrieved food product information from the remote computer system via the communication network. The portable electronic device may include a display screen, a telephone device, a camera device, an RFID reader device, or any combination thereof, for example.

In accordance with another aspect of the present invention, which will be summarized in this paragraph by describing example embodiments, a method for tracking nutritional information is provided, which includes: receiving at least one received electronic signal associated with at least one food product; at least one computer processor associating the at least one received electronic signal with a unique food product identifier stored in at least one database; the at least one computer processor associating the unique food product identifier with at least one nutritional information; the at least one computer processor analyzing at least one nutritional profile of at least one user profile based the at least one nutritional information; the at least one computer processor updating the at least one user profile with results of the analyzing for tracking the at least one nutritional information for the at least one user profile. The method may include the at least one computer processor associating the updated at least one user profile with at least one transmit electronic signal, and the at least one computer processor transmitting the at least one transmit electronic signal over a communication network. The target of the at least one computer processor transmitting the at least one transmit electronic signal over a communication network may be a telephone device. The analyzing of the at least one nutritional profile of at least one user profile based the at least one nutritional information may include analyzing the at least one nutritional information and at least one user defined information. The method may include disassociating at least part of the results of the analyzing for tracking the at least one nutritional information from the at least one user profile. All steps of the method may be performed within a same electronic device. The at least one received electronic signal may be indicative of at least one RFID for the at least one food product. The at least one received electronic signal may be indicative of at least one barcode for the at least one food product. The at least one received electronic signal may be indicative of at least one digital photograph for the at least one food product. The at least one received electronic signal may be received via the Internet. The at least one received electronic signal may be received at least in part via a keyboard. The at least one received electronic signal may be received at least in part via a mouse. The at least one received electronic signal may be received at least in part via an optical finger navigation device. The at least one received electronic signal may be received at least in part via at least one selection on a graphical user interface. The analyzing of the at least one nutritional profile of at least one user profile based the at least one nutritional information may include analyzing the at least one nutritional information and at least one dietary information. The analyzing of the at least one nutritional profile of at least one user profile based the at least one nutritional information may include one or more of the following operations: summing consumption, finding a mean consumption, finding a mode consumption, finding a median consumption, and finding a total consumption, finding a difference between daily consumption and recommended daily allowance, finding variance, and finding standard deviation.

The foregoing has outlined rather broadly features of the present invention through example embodiments in order that the detailed description of the invention that follows may be better understood. Additional features and advantages of the invention will be described hereinafter which also form the subject of the claims of the invention. The conception and specific embodiments disclosed may be readily utilized as a basis for modifying or designing other software apps, devices, methods, or processes for carrying out the same purposes and spirit of the present invention. It should also be realized by those skilled in the art that such equivalent embodiments do not depart from the spirit and scope of the invention as set forth in the appended claims.

### BRIEF DESCRIPTION OF THE DRAWINGS

The following is a brief description of the drawings, which illustrate exemplary embodiments of the present invention and in which:

FIG. 1 is a schematic of an embodiment of a nutritional information system;

FIGS. 2A-2E illustrate a collection of some exemplary means for collecting the food product identification;

FIG. 3 is a schematic for an embodiment with an exemplary graphical user interface displayed on a touch screen of a portable electronic device;

FIG. 4 is a schematic to illustrate some exemplary hardware and software components forming all or part of a nutritional information system for an embodiment of the present invention;

FIG. 5 is a schematic to illustrate some exemplary hardware and software components forming all or part of a nutritional information system for an embodiment of the present invention; and

FIGS. 6-26 are a series of flowcharts illustrating functional elements and/or steps that may be available and/or performed when implementing an embodiment of the present invention.

### DETAILED DESCRIPTION OF ILLUSTRATIVE EMBODIMENTS

Referring now to the drawings, wherein like reference numbers are used herein to designate like or similar elements throughout the various views, illustrative embodiments of the present invention are shown and described. The figures are not necessarily drawn to scale, and in some instances the drawings have been exaggerated and/or simplified in places for illustrative purposes only. One of ordinary skill in the art will appreciate the many possible applications and variations of the present invention based on the following illustrative embodiments of the present invention.

Nutritional information system embodiments of the present invention relate generally to a nutritional consumption tracking system, and more specifically to collecting and analyzing nutritional information of food products consumed by users. In various embodiments, this may be done, for example, on an individual level (group of one), family level (small group), or community level (large group). The collection and analysis of nutritional information related to a person, group, or community may be very useful to understand and control dietary patterns among other purposes. The nutritional information provided on the packaging of a food product may in various embodiments be collected based on consumption by a single user, and this information may be collected for each food product consumed in a day to calculate daily nutritional consumption. In this way, a person may watch what he/she eats in any given time period and make dietary adjustments based on this information.

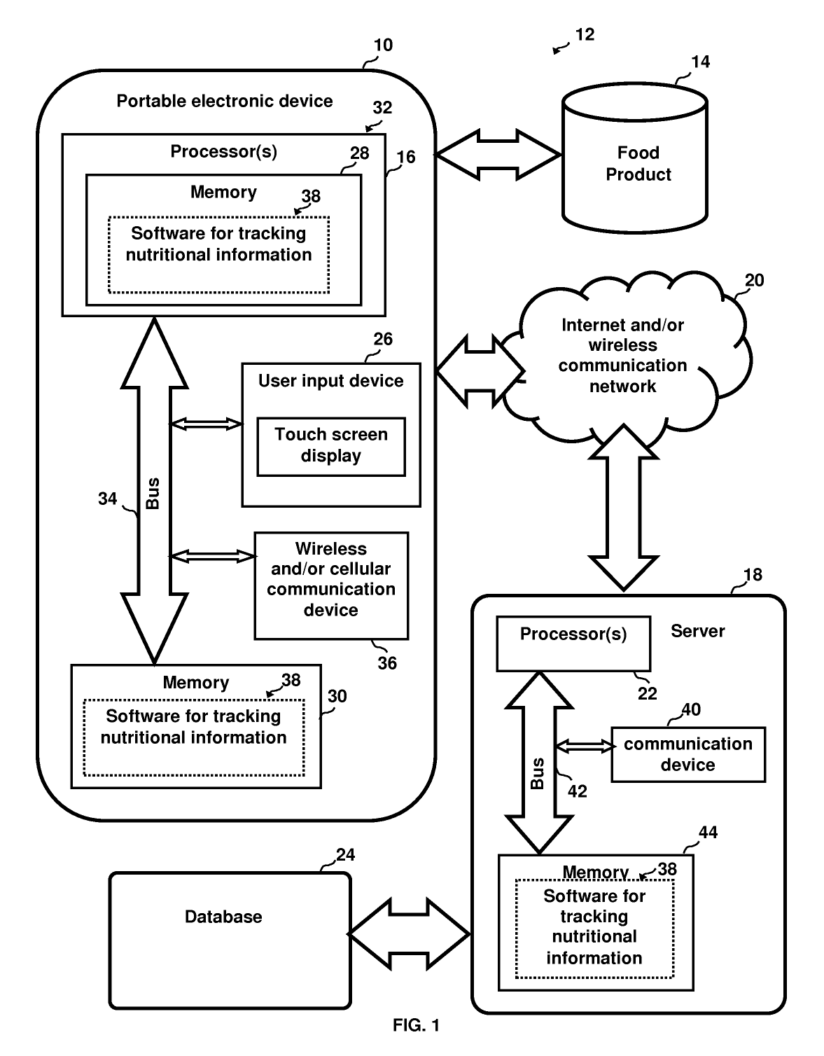

With the rise of handheld smart phones, and smaller computers, the nutritional information of food products consumed by a user may be received at, before, or shortly after the point of consumption. For example, FIG. 1 (discussed more below) shows an example embodiment making use of a handheld smart phone 10. This allows real time or close to real time updating of a user's food consumption. The system of an embodiment allows a user to control his/her diet and plan future food consumption based on real time or near real time consumption data. It also allows mathematical operations to be performed on a user's nutritional consumption information. This may be used in various embodiments to provide alerts to the user before the consumption. In addition, by storing this information in a database accessible via the Internet, for example, a user may go into their account and make corrections or adjustments to their nutritional consumption data to more accurately match what he/she actually consumed. An embodiment of the present invention allows a user to keep track of his/her consumption of food and drink products and thus to have greater knowledge of his/her diet. A user may make use of this information in a plurality of ways, such as losing weight, gaining weight, eating more healthily, cardiovascular health, diabetic intake limits, just tracking consumption, or combinations thereof, for example. A user may also keep track of food allergies and products that may set off the allergies, for example.

One embodiment of the present invention may be used to accurately provide real time diet information to a user based on food product consumption, and thus enable the user to track the food product consumption. In addition, another embodiment of the present invention may alert a user before the user consumes food products that would put the user over a specified limit, such as the FDA's recommended nutritional guidelines or daily allowances in real time or near real time (e.g., delay for transmission of data to/from a server and/or database, and/or delay by some periodic update interval).

Various embodiments provide systems, methods, and apparatus for a plurality of users to track a plurality of food products' nutritional information consumed by the user. By keeping track of the nutritional information of the food products a user consumes, the user may change his/her diet or at least know the nutritional information of the food they are eating.

Hence, a system of collecting and analyzing the nutritional information of food products consumed by a user is disclosed. In one embodiment, a user's computing device receives a food product identifier of a food product consumed by the user via RF ID (radio frequency identification), barcode, or similar means. The food product identifier is compared to the identifiers stored in a database. If matched, the associated nutritional information of the food product is stored in the user's database as consumed. The user's nutritional consumption information is then collected and analyzed and may be manipulated by the user to, among other things, control food product consumption or see patterns of food product consumption, for example.

In various embodiments, the type of nutritional information used by the system may include (but is not necessarily limited to), for example, serving size, servings per container, calories, calories from fat, total fat, saturated fat, trans fat, cholesterol, sodium, total carbohydrates, dietary fiber, sugars, protein, vitamin a, vitamin c, vitamin d, vitamin e, vitamin k, thiamin, riboflavin, niacin, vitamin b6, folic acid, vitamin b12, biotin, calcium, iron, phosphorus, iodine, magnesium, zinc, selenium, copper, manganese, chromium, molybdenum, chloride, potassium, boron, nickel, silicon, tin, producer/manufacturer, percentage of daily recommended amounts, purchase cost, location of purchase, category of food, unique identification number, point value or values, or combinations thereof. In various embodiments, different methods of receiving the food product's information may be used. The user may receive the food product's identification from any means (currently known or later developed input devices/means), including (but not necessarily limited to) barcode scanner, photograph, visual scanner, graphical user interface, keyboard, textual user interface, mouse, radio frequency antenna, optical navigation device, optical finger navigation device, touch screen, stylus input device, or any combination thereof, for example.

In another embodiment, the nutritional information associated with a food product may also be disassociated with a user's account. For example, this may be useful if a user makes a mistake in adding a food product to the user's account. In yet another embodiment, the nutritional information system may be a single database on a single computer. In another embodiment, a plurality of databases on a plurality of computers may store the nutritional information system, the nutritional information, the food product identification, the user's nutritional information, and the user's personal dietary information. In another embodiment, the nutritional information system may be stored on a plurality of computing devices such as smartphones, laptops, computers, tablet computer or P.D.A.s or the like. In another embodiment, the nutritional information system may be stored on a plurality of computing devices including computers and/or handheld devices. In yet another embodiment, the user's dietary information may be stored on a plurality of databases as well. Any type or combination of memory technology may be used to store the nutritional information at a user device and/or at a database and/or at a server, embedded in a processor chip (or system-on-chip) and/or separate and/or coupled by one or more buses and/or coupled by one or more communication connections/networks (e.g., Wifi, 802.11 protocols, WLAN, wire, wireless, cellular), including (but not necessarily limited to): hard disc drive, server drive, RAID, SRAM, DRAM, SDRAM, RAM, ROM, EPROM, EEPROM, cache, Flash, solid state drive, OTP, magnetic memory (e.g., FRAM), or phase change memory, as examples.

A user's dietary information may include (but not necessarily limited to) weight, height, activity level, FDA daily allowance levels, food allergies, medical allergies, a user-defined daily consumption level, or combinations thereof, for example. Consuming may include eating, drinking, use, intake, or combinations thereof, for example. Food product may include (but not necessarily limited to) food, drinks, vitamins, or any product with nutritional values greater than or equal to zero that may be consumed by the user, for example. Dietary information may include (but not necessarily limited to) weight, height, activity level, FDA daily allowance levels, food allergies, medical allergies, a user-defined daily consumption level, or combinations thereof, for example. Mathematical operations and/or data analysis may include (but not necessarily limited to) performing an operation on food product information, such as summing consumption, finding the mean consumption, finding the mode consumption, finding the median consumption, and finding the total consumption, finding the difference between daily consumption and recommended daily allowance, finding variance, finding standard deviation, or combinations thereof, for example. Analysis may involve performing a mathematical operation on food product information or user defined information, for example. A user's account may include the total nutritional information a user has consumed, for example.

In yet another embodiment, a user receives a message from the system if the user is about to consume a food product that would put the user above a user-defined limit. A user-defined limit may be food allergy, medical allergy, the food product would put the user above the FDA recommended daily allowance level, or some combination thereof, for example. In yet another embodiment, the user may receive a food product's information before it is consumed and check to ensure the consumption of the food product will fit into the user's diet. The user may receive a reply from the system informing him/her if the food product may be consumed with or without going over a user-defined limit, for example.

In another embodiment, the system or the user may define labels for different food products so that different food products may be grouped together. For example, a user may want to define junk food and have all junk food grouped together for analysis. In another embodiment, the nutritional information system may group foods together according to system defined categories such as healthy foods and unhealthy foods for analysis. In another embodiment, foods that come in bulk packages may be selected manually by the user from the database.

In another embodiment, a user's diet may be defined and the nutritional information system alerts the user when the user is getting close to the daily allowance of a certain category of nutritional information. For example, the user may define a daily allowance of 1300 calories, and the system may alert the user when the user is within 200 calories of the daily allowance. Or if sodium intake is to be limited, an alert may be sent to the user before, at the time of, or shortly after consumption, warning that sodium intake for a specific time period was high. The system may also alert the user when the user has gone over previously defined limits. For example, the system may alert the user when the user has consumed 1000 extra calories in a week or when the user has consumed an amount of candy bars over a previously defined limit.

In another embodiment, a user's nutritional information may be received and displayed to the user in real time. The user may access his/her nutritional consumption information from a plurality of devices, such as a smart phone, a computer, a television, or any Internet capable device, for example. In one embodiment, a user may keep track of her diet by scanning barcodes of the food products he/she consumes with his/her hand held computer or smart phone. The barcode data may be checked with a database of food product identifications, and if matched, the system may send the corresponding nutritional information to the user's database. After a plurality of food has been consumed by the user, the user may see his/her total nutritional intake based on a plurality of time periods, such as a meal, a day, a week, multiple weeks, years, etc., for example.

In another embodiment, a user may select the food product consumed from a list generated on a computer interface (e.g., touch screen on smart phone or computer pad/tablet device). The computer interface may be graphical, touch screen, text based, or input by the user with a keyboard or mouse or other input means (e.g., voice recognition, motion tracking, etc.), for example. This may be done to augment the user's food product information coming from another source, or this may be the single means to receiving the user's food product information, for example. In an embodiment, a mathematical operation may be performed on the user's consumed nutritional information. For example, a list of mathematical operations that a user may want to know may include (but not necessarily limited to) summing consumption, finding the mean consumption, finding the mode consumption, finding the median consumption, and finding the total consumption, finding the difference between daily consumption and recommended daily allowance, finding variance, finding standard deviation, or combinations thereof, for example. In an embodiment, a category of food may include (but not necessarily limited to) the food pyramid, another sanctioned food category system, food groups, or combinations thereof, for example. This may be used to determine the levels of nutritional intake a user should have in a given time period. For example, with an embodiment a user may base their maximum caloric intake levels on the food pyramid and an alert may be sent if a user consumes close to or above the recommended daily calorie intake. In an embodiment, the nutritional information system may receive workout information as well as food information so that a user's total intake and usage of nutritional information may be calculated. For example, a user's total calories burned may be received by the system and used in conjunction with the user's total calories consumed in the day to determine the user's total net caloric intake.

In an embodiment, a unique identification number may be assigned to the food product such that it may be used as a separate identification of the food product. It may also be used as a pointer or internally in the database system to reference food products. In an embodiment, points may be assigned to food products based on nutritional information or other information. Such points may then be tracked, recorded, tallied, used for analysis, other means, or combinations thereof, for example. In an embodiment, a user may input the percentage of the product or serving that was consumed. In an embodiment, a CPU may upload and download information from the database in real time. In an embodiment, the CPU may upload and download information from the database only when a user inputs a certain command. In an embodiment, a CPU may upload and download information from the database only at certain times such as periodically or when docked to a computer. In an embodiment, the receiver, CPU, and database may be contained in a single device. In a certain embodiment of the system on a single device, the system may operate independently of the Internet (always, at certain times, for certain time intervals, by default and/or as user defined). In an embodiment, a user's handheld device may connect to the Internet to query the database. In an embodiment, a user's handheld device may not contain the CPU (for data analysis and/or mathematical operations, or for generating code for a graphical user display or html) or the database and it only transmits, receives, and displays a unique food product identifier or a user's nutritional information from the Internet.

With reference to FIG. 1, a nutritional information system 12 according to an embodiment of the present disclosure is referred to. The handheld device 10 receives or reads the food product identification for a food product 14. According to one embodiment for example, the product identification is received via radio frequency signal by the handheld device 10. After receiving the food product's product identification, handheld device 10 uses its processor(s) 16 to decode the product identification. Once the food product's product identification has been decoded by handheld device's processor(s) 16, the food product identification and the user identification are transmitted to a server 18 (e.g., via communication network 20). In another embodiment, handheld device 10 transmits food product's product identification and user identification to a server 18 or another device via radio frequency signal. The server 18 uses its processor(s) 22 to compare the transmitted user identification and the food product's product identification with a database 24 (or the database 24 may pictorially represent, in schematic form, a plurality of databases at one or more physical locations). If a match is found, the server's processor(s) 22 decodes the food product's nutritional information. The server computer 18 also may store the total nutritional information for the user in the database 24. In the illustrated embodiment, the user interface or user input device 26 (e.g., touch screen display) is used to access and display the user's nutritional information. In another embodiment, the server 18 may be implemented by dispersed processing capabilities such as multiple computers at one or more physical locations. In another embodiment, the server 18 may be virtual such as in a cloud computer system.

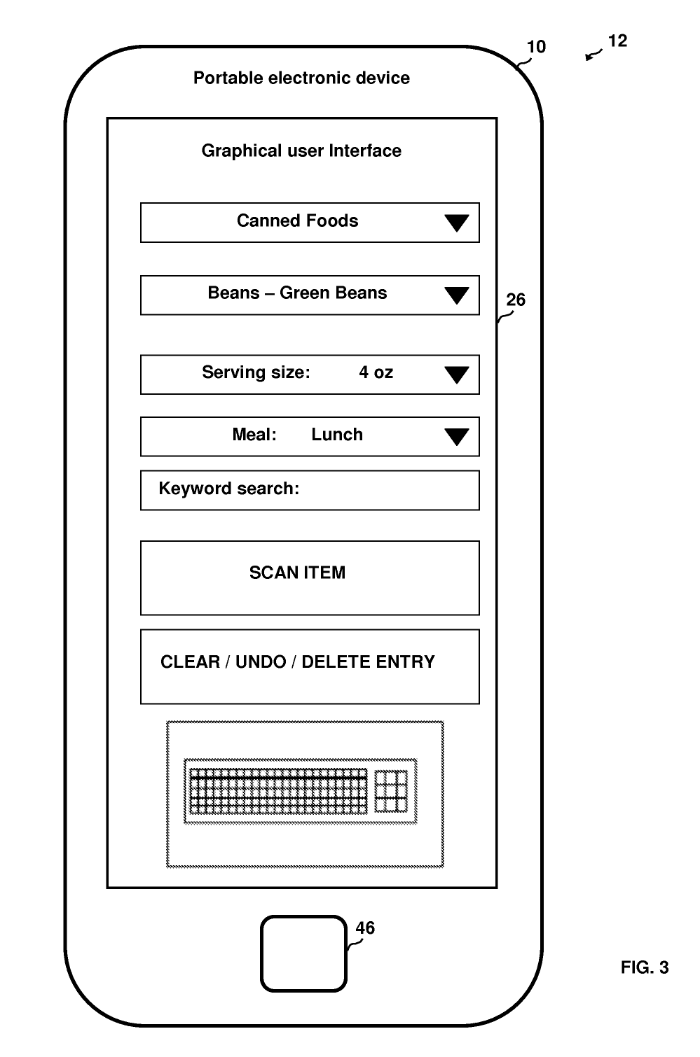

In another embodiment, the handheld device 10 then receives server's transmission of total user nutritional information and food product's nutritional information. In one embodiment, such transmission sends the food product's nutritional information via radio frequency signals. Handheld device's processor(s) 16 decodes the nutritional information for the user and displays that information on the user interface 26. A user may use the user interface 26 to transmit and receive information to and from the nutritional information system (e.g., via touch screen, keypad, mouse, optical navigation device, trackball). The user interface 26 of an embodiment may include a plurality of interface types, such as graphical images and text (see e.g., FIG. 3 discuss more below).

Next, the example embodiment shown in FIG. 1 will be described in more detail, and may further include any combination of features from other embodiments described herein. FIG. 1 is a schematic to illustrate some exemplary hardware and software components forming a nutritional information system 12. A portable electronic device 10 (e.g., smart phone, tablet computer, pad computer) includes one or more processors 16 and one or more memory devices 28, 30. As shown in FIG. 1, a system on chip device 32 may include one or more processors 16 and one or more embedded memory devices 28 (e.g., SRAM, Flash), as well as video and audio encoders and/or decoders. The device 10 may include one or more buses 34 (e.g., integrated circuit conducting lines on chip, printed circuit board, wire bundle, or combinations thereof) for connecting various components together. The device 10 may include a larger memory array 30 (e.g., Flash) coupled to the processor(s) 16 by a bus 34 on a motherboard (e.g., printed circuit board. The device 10 of FIG. 1 includes wireless communication devices (block 36) (e.g., WiFi, Bluetooth, or other 802.11 compliant devices). The device 10 of FIG. 1 also includes a cellular communication device (block 36), which may be used to transmit data (e.g., 3G, 4G, etc.) and voice communications (e.g., CDMA, GSM) for use as a cell phone. The device 10 of FIG. 1 further includes user input devices 26, which includes a touch screen display. As illustrated in other embodiments discussed below, the user input devices 26 may include devices for obtaining information about the food products (e.g., camera, RFID reader, bar code scanner). The portable device 10 of FIG. 1 is configured to transmit and receive data to communication networks 20 (e.g., cellular, wireless protocols, Internet protocols). The software 38 for tracking nutritional information may be stored in one or more memory devices 28, 30 of the portable electronic device 10. In some cases, the entire software may be stored in a larger memory device 30 and then portions transferred into volatile memory 28 (e.g., DRAM) for execution by the processor(s) 16.

The nutritional information system 12 of FIG. 1 includes a server 18. The portable electronic device 10 may transfer data to/from the server 18 via one or more communication networks 20 (e.g., wired, fiber optic, microwave transmission devices, trunks, lines, switches, routers, wireless communication devices, satellite, cellular towers, telephone networks, Internet networks, etc.). The server 18 includes one or more processor(s) 22, one or more communication devices 40, one or more buses 42, and one or more memory devices 44. The server 18 is connected to or may include one or more databases 24 for store large amounts of data and information for multiple user accounts/profiles. The server 18 represented schematically in FIG. 1 may be one or more computer devices at one or more physical locations. The database 24 represented schematically in FIG. 1 may be one or more databases at one or more physical locations, which may or may not coincide with the physical location of the one or more servers 18. In an embodiment, a portion of the software 38 for tracking nutritional information may be located in one or more memories 44 of the server(s) 18. In an embodiment, the portable electronic device 10 may only run a smaller software app that retrieves analyzed data from a server 18 where a more complex and larger software program resides and performs most or all of the mathematical computations and algorithms. In such case, the server 18 may simply transmit a graphical user interface code (e.g., html or app formatted data) to the portable electronic device 10 to reduce the amount of processor power and battery power usage needed by the portable electronic device 10.

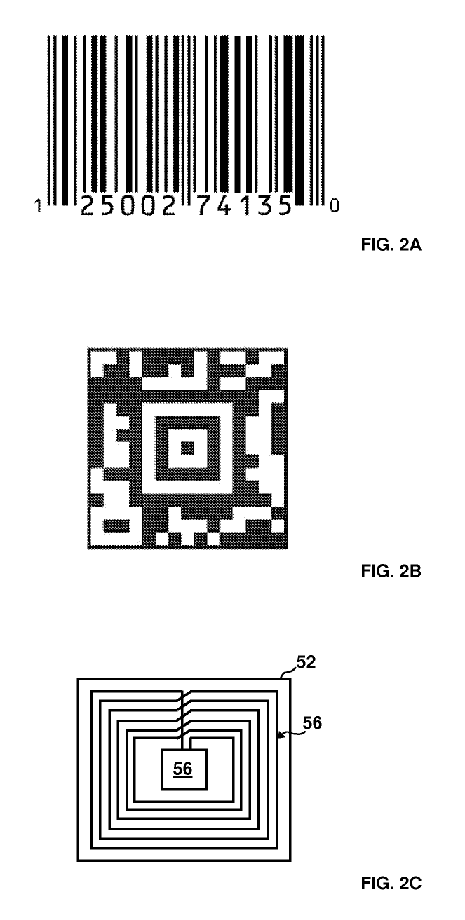

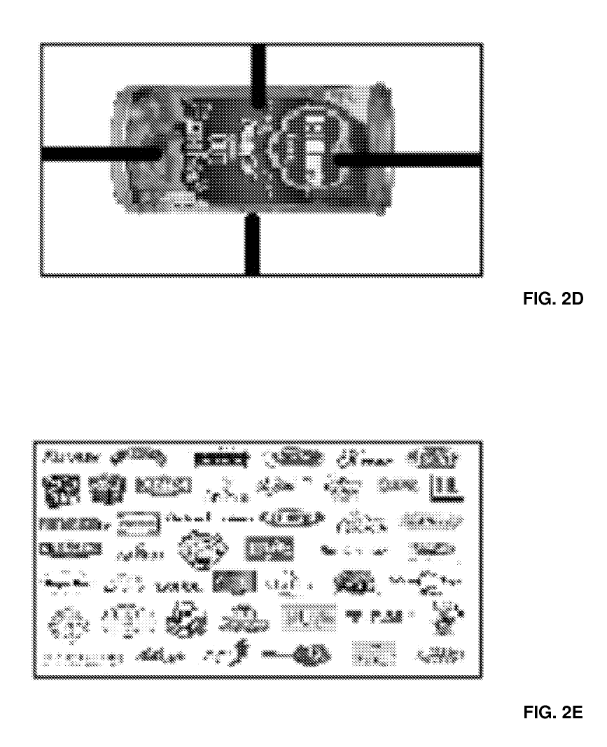

FIGS. 2A-2E are a collection of some exemplary means for collecting the food product identification. FIG. 2A depicts a barcode. In an embodiment, the user scans the barcode on a food product or label, which is then decoded to identify the food product. FIG. 2B depicts a mosaic of black and white rectangles. In an embodiment, the user scans the mosaic of black and white rectangles on a food product or label or advertisement, which is then decoded to identify the food product. Such scanning may be by a dedicated scanner or by a camera device that generates a digital image of the barcode or mosaic of black and white rectangles. In the same way other types of barcodes, like a pattern of dots or squares in contrasting colors may be used as well. FIG. 2C depicts an RFID tag, which includes a semiconductor chip and a radio frequency antenna. In an embodiment, the user calls for a response from or receives a radio frequency signal from the RFID of the RFID tag on a on a food product or label using an RFID reader device. Then the radio frequency signal emitted from the RFID tag is decoded to identify the food product. FIG. 2D depicts a photograph or digital image obtained by a camera device of a food product. In an embodiment, such photograph of a food product is used by the system to identify the food product, e.g., by image recognition software. For example, the photograph may be compared with previously taken photographs of food products to determine if a match is found. FIG. 2E depicts an example screen display on a graphical user interface (non-touch interactive screen or touch interactive screen). In an embodiment, the user may manipulate a data screen or computer through a graphical user interface to select the food products. For example, this may be done by voice recognition, mouse click, keyboard, optical navigation device selection, touch-screen, or any combination thereof. The images may be a logo, a product image, a logo combined with text, or some other graphical indicator of a given product, for example. In an embodiment, the graphical representation of a product may simply be text describing the product on a user's screen. The user may select the food product based on text characters alone. Also, a search box may be provided for inputting text for performing a search for a given food product from a list or database (e.g., using keyboard type interface device). As another example, the selection of product from one or more choices displayed on a graphical user interface may be done by voice commands (e.g., using voice recognition software) or touch-screen.

FIG. 3 is a simplified schematic showing an embodiment with an exemplary graphical user interface 26 displayed on a touch screen of a portable electronic device 10, which may include any combination of features from other embodiments described herein. For example, the graphical user interface 26 of FIG. 3 includes a drop down menu for selecting food packaging type or category, a drop down menu for selecting a more specific food product, a drop down menu for selecting serving size consumed, and a drop down for selecting which meal. For example, the graphical user interface of FIG. 3 further includes a keyword search or query portion for typing in keywords to search, a scan item button for engaging the use of a scanner device (e.g., camera, RFID reader, barcode reader, etc.), a button for clearing, undoing, or deleting an entry, and an on screen keyboard. In some embodiments, the portable electronic device may include a physical keyboard. The device 10 of FIG. 3 further includes an optical navigation device 46 (for providing cursor movement, click to select, and other mouse functions).

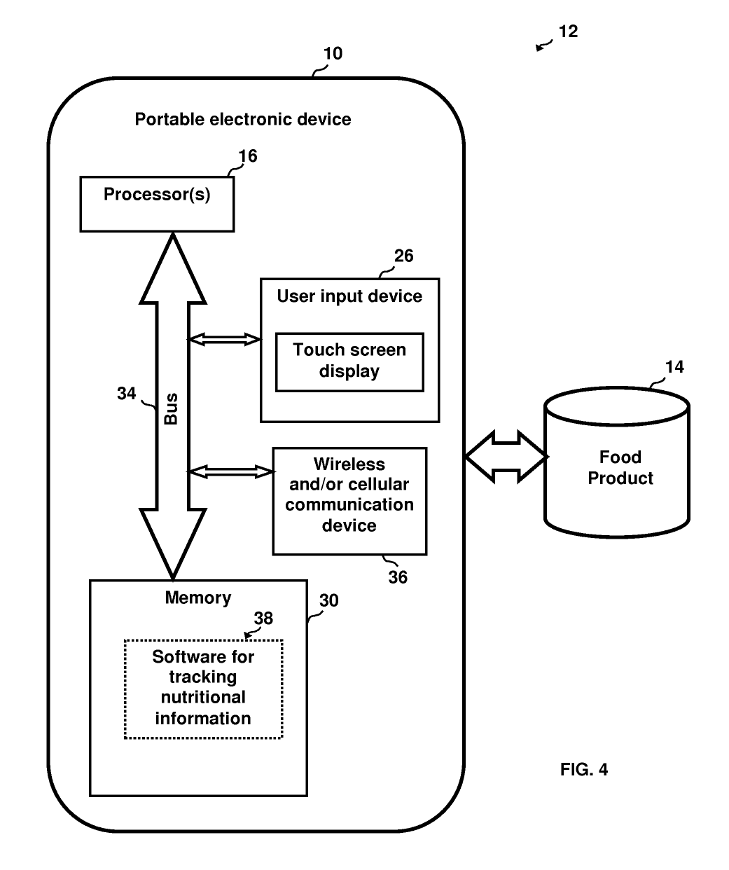

Next, another exemplary embodiment (which may include any combination of features from other embodiments described herein) shown in FIG. 4 will be described in more detail. FIG. 4 is a schematic to illustrate some exemplary hardware and software components forming all or part of a nutritional information system 12. The portable electronic device 10 of FIG. 4 includes a touch screen display 26 for inputting information about the food product 14 or selecting the food product from lists or menu choices. In the device 10 of FIG. 4, the processor(s) 16 are separate from the memory 30 where the software 38 for tracking nutritional information is stored, and are connect by one or more buses 34.

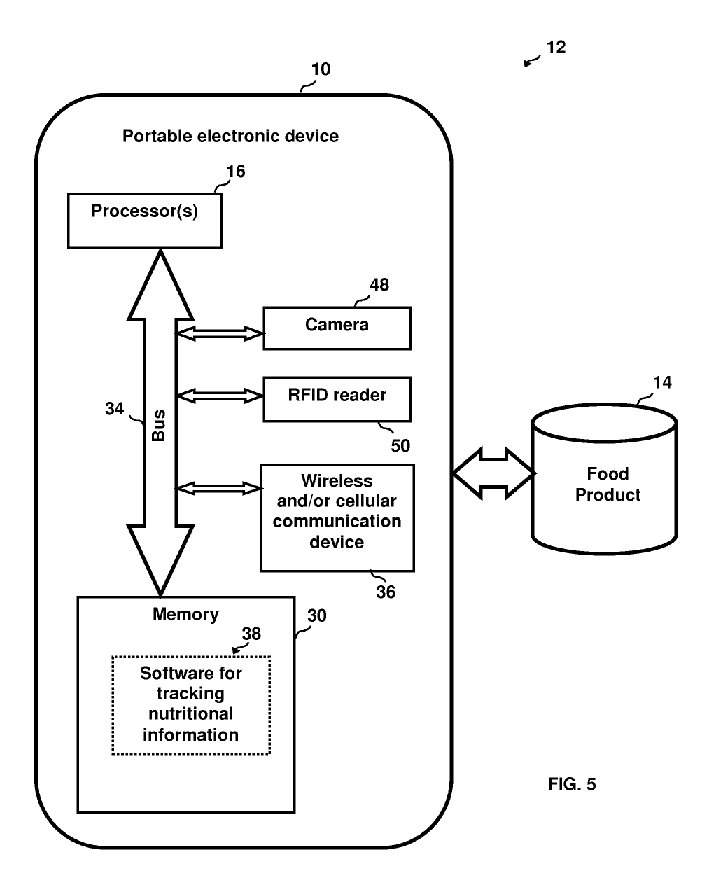

Next, another exemplary embodiment (which may include any combination of features from other embodiments described herein) shown in FIG. 5 will be described in more detail. FIG. 5 is a schematic to illustrate some exemplary hardware and software components forming all or part of a nutritional information system 12. The portable electronic device 10 of FIG. 5 includes a camera device 48, which may be used to capture images of the food product 14 or its label information, such as a bar code or dot grid code, for example. The portable electronic device 10 of FIG. 5 further includes an RFID reader device 50, which may be used to receive radio frequency transmissions from an RFID tag of a food product 14, for example. Preferably, the RFID reader device 50 is a low power version with limited distance range to avoid activating or picking up RFID tag signals in other nearby food products, and to save battery power.

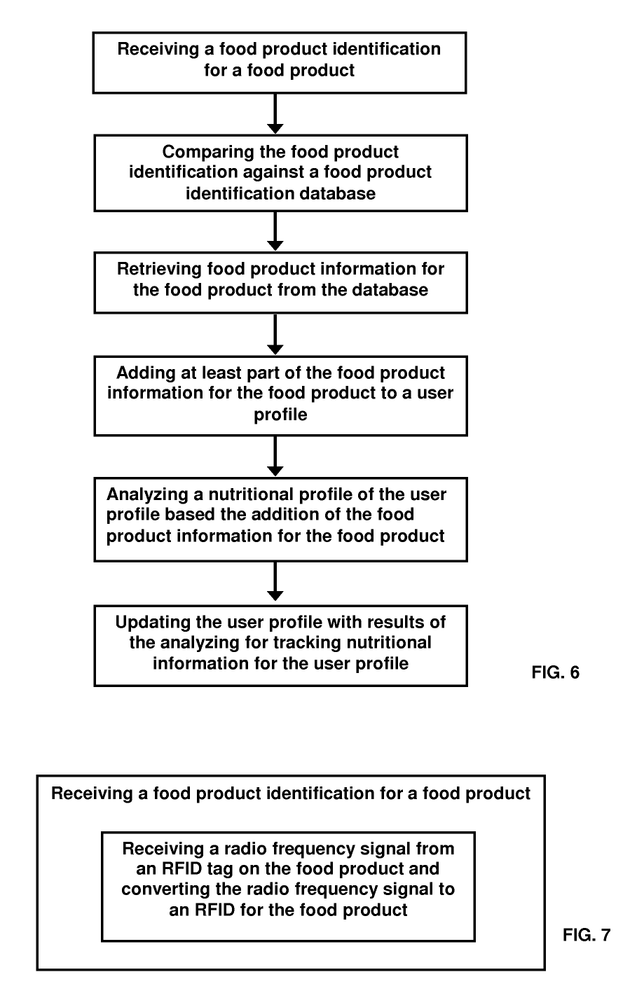

Next, a series of flowcharts shown in FIGS. 6-26 will be described, which illustrate functional elements and/or steps that may be available and/or performed when implementing an embodiment of the present invention, and any of which may include any combination of features, functions, and/or elements from other embodiments described herein. Such steps and elements of FIGS. 6-26 may be considered pseudo code for software and/or firmware that may be implemented in an embodiment of the present invention for example. Such steps and elements of FIGS. 6-26 may be methods steps to generally describe what an embodiment may do.

FIG. 6 illustrates an example flow for making use of an embodiment of the present invention in which a computer-implemented method for tracking nutritional information is provided. A food product identification for a food product is received. The food product identification is compared against a food product identification database. Food product information for the food product is retrieved from the database. At least part of the food product information for the food product is added or updated to a user profile. A nutritional profile of the user profile is analyzed based the addition of the food product information for the food product. The user profile is updated with results of the analyzing for tracking nutritional information for the user profile.

The method may be performed or the software may be executed in a computer system including at least one memory and at least one processor. The receiving of the food product identification may be performed by the computer system via a communication network. The food product identification may have been previously obtained at a remote location with a portable electronic device and transmitted to the computer system by the portable electronic device (see e.g., FIG. 1). The method or software functionality may include transmitting at least part of the updated user profile to the portable electronic device. The method or software functionality may include formatting the at least part of the updated user profile in a graphical display format compatible with the portable electronic device prior to the transmitting. The method or software functionality may be performed in a portable electronic device including at least one memory and at least one processor. The database may stored in the at least one memory of the portable electronic device. The method or software functionality may include requesting updates for the database via a communication network, and receiving updates for the database via the communication network.

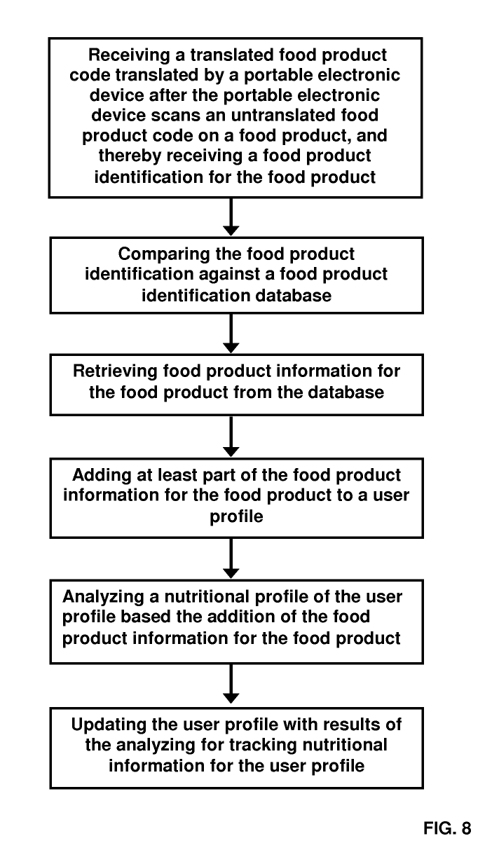

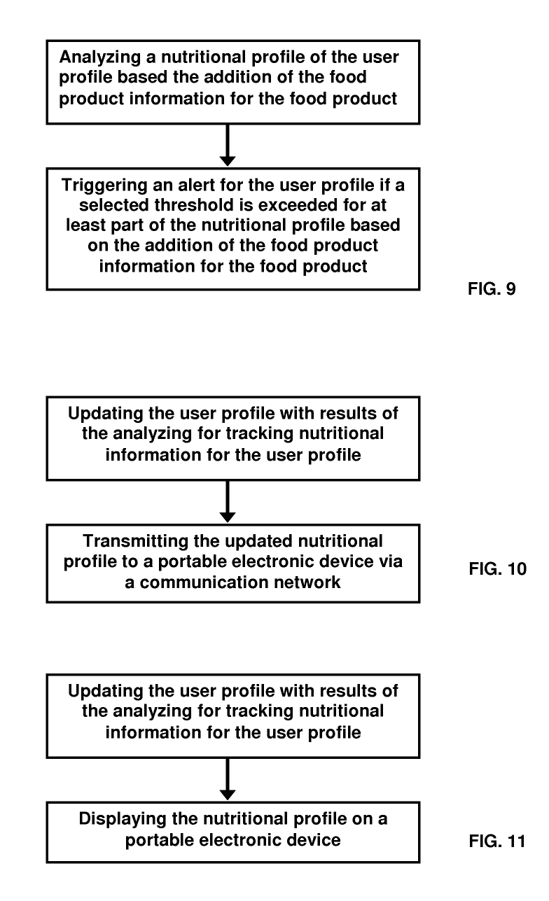

As illustrated in FIG. 7, the receiving of the food product identification may include receiving a radio frequency signal from an RFID tag on the food product and converting the radio frequency signal to an RFID for the food product. As illustrated in FIG. 8, the receiving of the food product identification may include receiving a translated food product code translated by a portable electronic device after the portable electronic device scans an untranslated food product code on a food product (e.g., bar code, RFID). As illustrated in FIG. 9, the analyzing a nutritional profile of the user profile based the addition of the food product information for the food product may trigger an alert for the user profile if a selected threshold is exceeded for at least part of the nutritional profile based on the addition of the food product information for the food product. As illustrated in FIG. 10, after updating the user profile with results of the analyzing for tracking nutritional information for the user profile, the updated nutritional profile may be transmitted to a portable electronic device via a communication network. As illustrated in FIG. 11, after updating the user profile with results of the analyzing for tracking nutritional information for the user profile, the nutritional profile may be displayed on a portable electronic device.

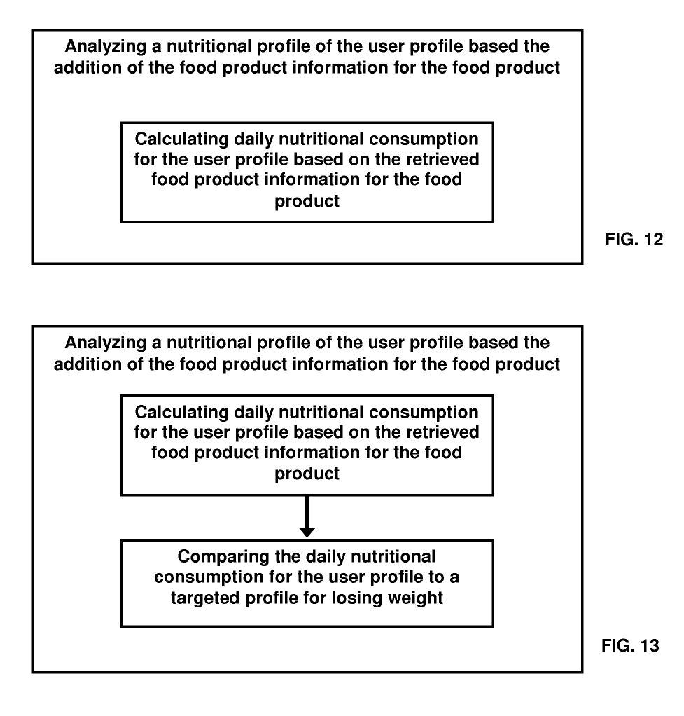

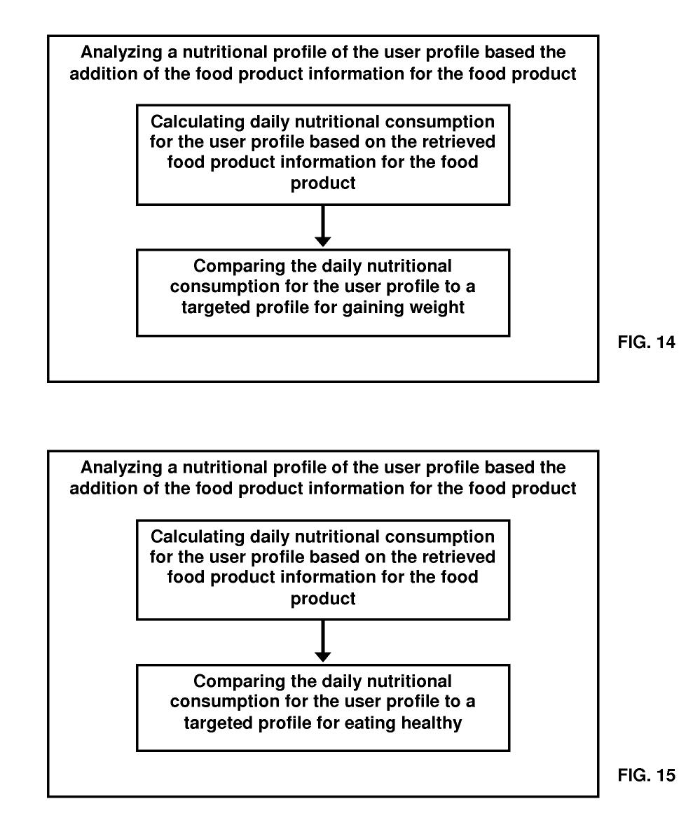

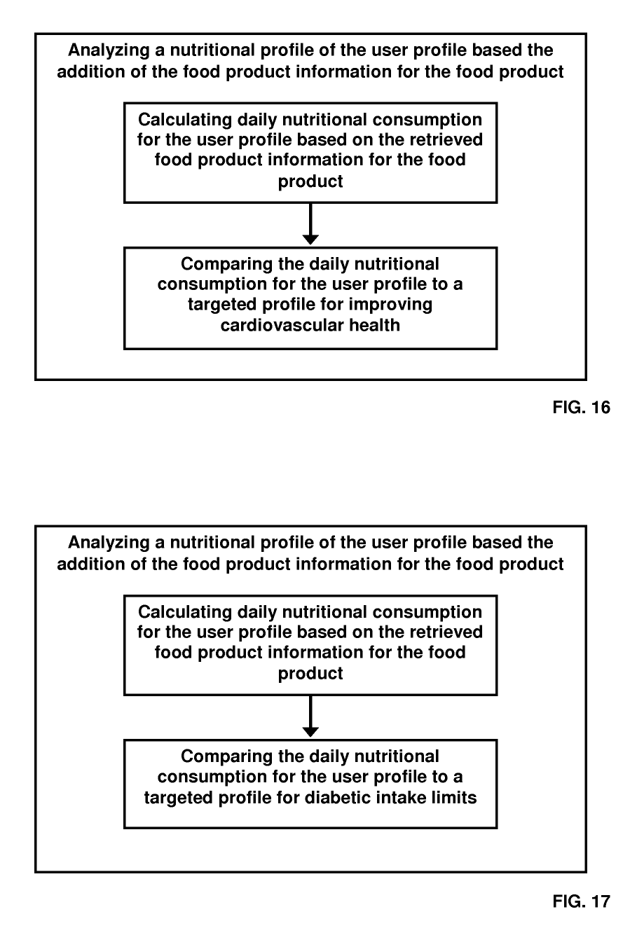

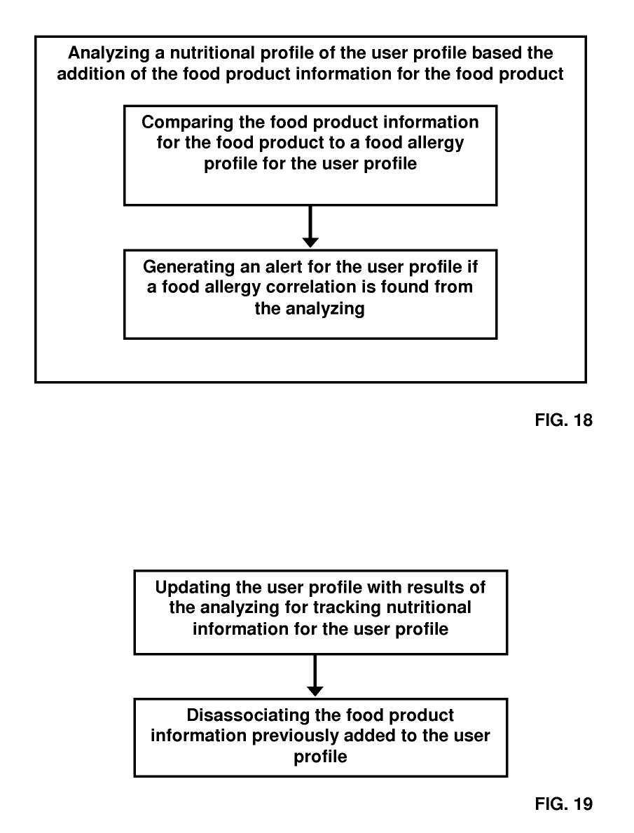

As illustrated in FIG. 12, the analyzing a nutritional profile of the user profile based the addition of the food product information for the food product may include calculating daily nutritional consumption for the user profile based on the retrieved food product information for the food product. As illustrated in FIG. 13, the analyzing a nutritional profile of the user profile based the addition of the food product information for the food product may further include comparing the daily nutritional consumption for the user profile to a targeted profile for losing weight. As illustrated in FIG. 14, the analyzing a nutritional profile of the user profile based the addition of the food product information for the food product may further include comparing the daily nutritional consumption for the user profile to a targeted profile for gaining weight. As illustrated in FIG. 15, the analyzing a nutritional profile of the user profile based the addition of the food product information for the food product may further include comparing the daily nutritional consumption for the user profile to a targeted profile for eating healthy. As illustrated in FIG. 16, the analyzing a nutritional profile of the user profile based the addition of the food product information for the food product may further include comparing the daily nutritional consumption for the user profile to a targeted profile for improving cardiovascular health. As illustrated in FIG. 17, the analyzing a nutritional profile of the user profile based the addition of the food product information for the food product may further include comparing the daily nutritional consumption for the user profile to a targeted profile for diabetic intake limits. As illustrated in FIG. 18, the analyzing a nutritional profile of the user profile based the addition of the food product information for the food product may include comparing the food product information for the food product to a food allergy profile for the user profile and generating an alert for the user profile if a food allergy correlation is found from the analyzing.

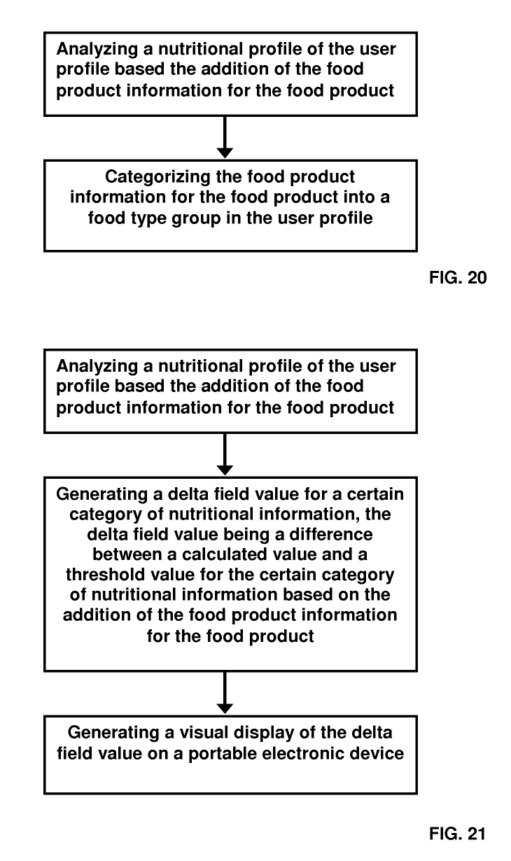

As illustrated in FIG. 19, the updating the user profile with results of the analyzing for tracking nutritional information for the user profile may include or may be followed by disassociating the food product information previously added to the user profile (e.g., if the user makes a mistake, if a user does not end up consuming all or part of the item). As illustrated in FIG. 20, after analyzing a nutritional profile of the user profile based the addition of the food product information for the food product, the food product information for the food product may be categorized into a food type group in the user profile.

As illustrated in FIG. 21, after analyzing a nutritional profile of the user profile based the addition of the food product information for the food product, a delta field value for a certain category of nutritional information may be generated. The delta field value may be a difference between a calculated value and a threshold value for the certain category of nutritional information based on the addition of the food product information for the food product. Then, a visual display of the delta field value may be generated on a portable electronic device.

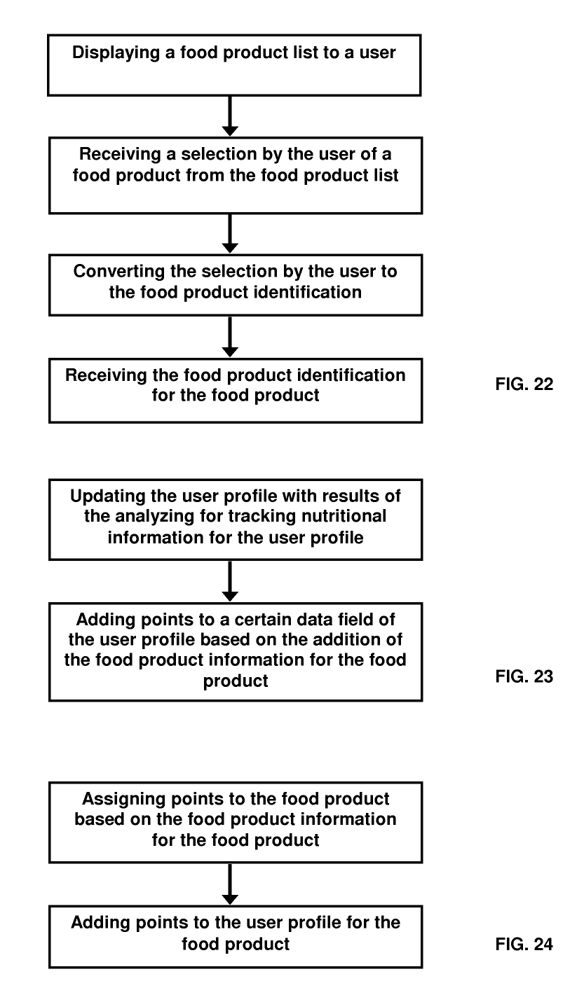

As illustrated in FIG. 22, before receiving a selection by the user of a food product from the food product list, a food product list or menu may be provided or displayed to a user. The selection by the user is then converted to the food product identification (at the portable electronic device and/or at a server or other computer device). As illustrated in FIG. 23, the updating of the user profile with results of the analyzing for tracking nutritional information for the user profile may include a step of adding points to a certain data field of the user profile based on the addition of the food product information for the food product. FIG. 24 illustrates another variation in which points are assigned to the food product based on the food product information for the food product, and points are added to or subtracted from the user profile for the food product. Such assignment may be provided by the food manufacturer, by the software provider, by the user, by a standard setting body, by a group or organization tasked with creating such parameters, or any combination thereof, for example.

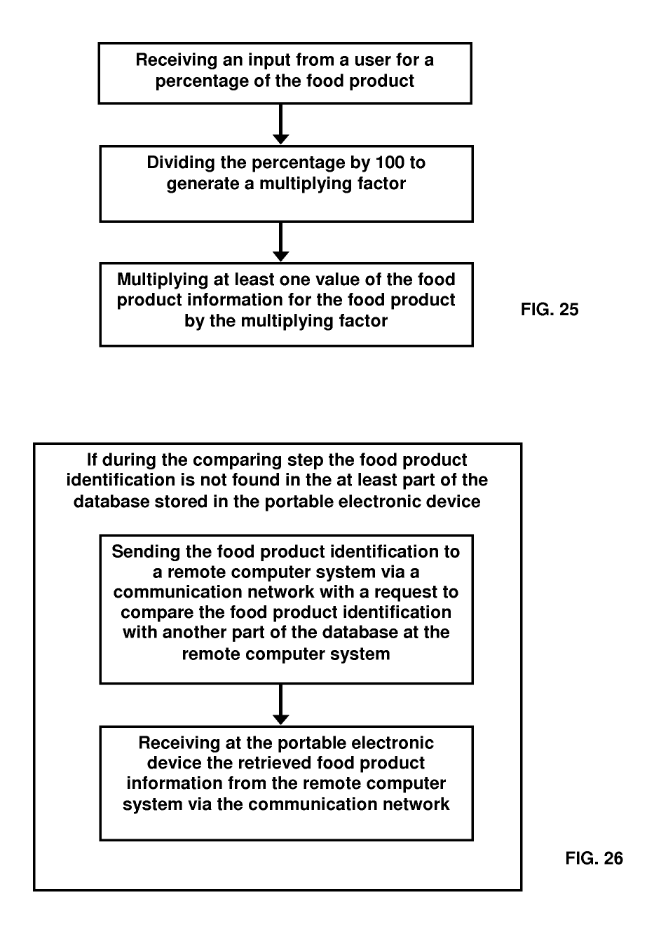

As illustrated in FIG. 25, a user may input a percentage of the food product (e.g., percentage consumed of a container or of a standard amount). Then, the percentage may be divided by 100 to generate a multiplying factor and multiplied to at least one value of the food product information for the food product. This may be part of the analyzing of the food product information for the user's profile.

Referring now to FIG. 26, if during the comparing step the food product identification is not found in the at least part of the database stored in the portable electronic device, the food product identification may be sent to a remote computer system via a communication network (or by other means of communication) with a request to compare the food product identification with another part of the database at the remote computer system. Then the portable electronic device receives the retrieved food product information from the remote computer system via the communication network (or by other means of communication).

Although embodiments of the present invention and at least some of its advantages have been described in detail, it should be understood that various changes, substitutions, and alterations can be made herein without departing from the spirit and scope of the invention as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A non-transitory computer readable medium including at least executable computer program code tangibly stored therein for tracking nutritional information, the computer readable medium comprising:
computer program code for receiving a food product identification for a food product;
computer program code for comparing the food product identification against a food product identification database;
computer program code for retrieving food product information for the food product from the database;
computer program code for adding at least part of the food product information for the food product to a user profile;
computer program code for analyzing a nutritional profile of the user profile based on the addition of the food product information for the food product; and
computer program code for updating the user profile with results of the analyzing for tracking nutritional information for the user profile.

2. The computer readable medium of claim 1, wherein the receiving of the food product identification comprises receiving an RFID for the food product.

3. The computer readable medium of claim 1, wherein the receiving of the food product identification comprises receiving a bar code for the food product.

4. The computer readable medium of claim 1, wherein the receiving of the food product identification comprises receiving a visual image of a code on the food product.

5. The computer readable medium of claim 1, wherein the receiving of the food product identification comprises receiving a radio frequency signal from an RFID tag on the food product and converting the radio frequency signal to an RFID for the food product.

6. The computer readable medium of claim 1, wherein the receiving of the food product identification comprises receiving a translated food product code translated by a portable electronic device after the portable electronic device scans an untranslated food product code on the food product.

7. The computer readable medium of claim 6, wherein the untranslated food product code comprises a barcode.

8. The computer readable medium of claim 6, wherein the untranslated food product code comprises a radio frequency signal that includes an RFID for the product.

9. The computer readable medium of claim 6, wherein the untranslated food product code comprises a mosaic of black and white rectangles.

10. The computer readable medium of claim 1, further comprising computer program code for triggering an alert for the user profile if a selected threshold is exceeded for at least part of the nutritional profile based on the addition of the food product information for the food product.

11. The computer readable medium of claim 1, further comprising computer program code for transmitting the updated nutritional profile to a portable electronic device via a communication network.

12. The computer readable medium of claim 11, wherein the communication network is the Internet.

13. The computer readable medium of claim 11, wherein the communication network is a cellular telephone communication network.

14. The computer readable medium of claim 1, further comprising computer program code for displaying the nutritional profile on a portable electronic device.

15. The computer readable medium of claim 1, wherein the analyzing of the nutritional profile comprises calculating daily nutritional consumption for the user profile based on the retrieved food product information for the food product.

16. The computer readable medium of claim 15, wherein the analyzing of the nutritional profile comprises comparing the daily nutritional consumption for the user profile to a targeted profile for losing weight.

17. The computer readable medium of claim 15, wherein the analyzing of the nutritional profile comprises comparing the daily nutritional consumption for the user profile to a targeted profile for gaining weight.

18. The computer readable medium of claim 15, wherein the analyzing of the nutritional profile comprises comparing the daily nutritional consumption for the user profile to a targeted profile for eating healthy.

19. The computer readable medium of claim 15, wherein the analyzing of the nutritional profile comprises comparing the daily nutritional consumption for the user profile to a targeted profile for improving cardiovascular health.

20. The computer readable medium of claim 15, wherein the analyzing of the nutritional profile comprises comparing the daily nutritional consumption for the user profile to a targeted profile for diabetic intake limits.

21. The computer readable medium of claim 1, wherein the analyzing of the nutritional profile comprises comparing the food product information for the food product to a food allergy profile for the user profile.

22. The computer readable medium of claim 21, further comprising computer program code for generating an alert for the user profile if a food allergy correlation is found from the analyzing.

23. The computer readable medium of claim 1, further comprising computer program code for disassociating the food product information previously added to the user profile.

24. The computer readable medium of claim 1, further comprising computer program code for categorizing the food product information for the food product into a food type group in the user profile.

25. The computer readable medium of claim 1, further comprising computer program code for generating a delta field value for a certain category of nutritional information, the delta field value being a difference between a calculated value and a threshold value for the certain category of nutritional information based on the addition of the food product information for the food product.

26. The computer readable medium of claim 25, further comprising computer program code for generating a visual display of the delta field value on a portable electronic device.

27. The computer readable medium of claim 1, further comprising:
computer program code for displaying a food product list to a user;
computer program code for receiving a selection by the user of the food product from the food product list; and
computer program code for converting the selection by the user to the food product identification.

28. The computer readable medium of claim 1, further comprising computer program code for adding points to a certain data field of the user profile based on the addition of the food product information for the food product.

29. The computer readable medium of claim 1, further comprising computer program code for assigning points to the food product based on the food product information for the food product.

30. The computer readable medium of claim 29, further comprising computer program code for adding points to the user profile for the food product.

31. The computer readable medium of claim 1, further comprising computer program code for receiving an input from a user for a percentage of the food product.

32. The computer readable medium of claim 31, further comprising:
computer program code for dividing the percentage by 100 to generate a multiplying factor; and
computer program code for multiplying at least one value of the food product information for the food product by the multiplying factor.

33. The computer readable medium of claim 1, wherein the computer program code for analyzing includes at least one operation selected from a group of summing consumption, finding a mean consumption, finding a mode consumption, finding a median consumption, and finding a total consumption, finding a difference between daily consumption and recommended daily allowance, finding variance, and finding standard deviation.

34. A software application configured to execute on at least one processor of a portable electronic device when stored in a non-transitory computer readable medium on the portable electronic device, the software application including at least executable computer program code for tracking nutritional information, comprising:
computer program code for receiving product packaging information for a food product;
computer program code for requesting a conversion of the product packaging information to a food product identification for the food product;
computer program code for requesting a comparison of the food product identification against a food product identification database;
computer program code for retrieving food product information for the food product from the database;
computer program code for adding at least part of the food product information for the food product to a user profile;
computer program code for analyzing a nutritional profile of the user profile based the addition of the food product information for the food product; and
computer program code for updating the user profile with results of the analyzing for tracking nutritional information for the user profile.

35. The software application of claim 34, wherein the conversion of the product packaging information to the food product identification for the food product is performed by the at least one processor of the portable electronic device.

36. The software application of claim 34, wherein the conversion of the product packaging information to the food product identification for the food product is performed by a remote computer system after the portable electronic device transmits the product packaging information via a communication network.

37. The software application of claim 34, wherein the comparison of the food product identification against a food product identification database is performed by the at least one processor of the portable electronic device.

38. The software application of claim 34, wherein the comparison of the food product identification against a food product identification database is performed by a remote computer system after the portable electronic device transmits the product packaging information to the remote computer system via a communication network.

39. The software application of claim 34, wherein the comparison of the food product identification against a food product identification database is performed by a remote computer system after the portable electronic device transmits the food product identification to the remote computer system via a communication network.

40. The software application of claim 34, wherein the retrieving food product information for the food product from the database is performed by the portable electronic device.

41. The software application of claim 34, wherein the retrieving food product information for the food product from the database is performed by a remote computer system.

42. The software application of claim 34, wherein the adding at least part of the food product information for the food product to the user profile is performed by the portable electronic device.

43. The software application of claim 34, wherein the adding at least part of the food product information for the food product to the user profile is performed by a remote computer system.

44. The software application of claim 34, wherein the analyzing of the nutritional profile of the user profile based the addition of the food product information for the food product is performed by the portable electronic device.

45. The software application of claim 34, wherein the analyzing of the nutritional profile of the user profile based the addition of the food product information for the food product is performed by a remote computer system.

46. The software application of claim 34, wherein the updating of the user profile with results of the analyzing for tracking nutritional information for the user profile is performed by the portable electronic device.

47. The software application of claim 34, wherein the updating the user profile with results of the analyzing for tracking nutritional information for the user profile by a remote computer system, and further comprising transmitting the updated user profile from the remote computer system to the portable electronic device via a communication network.

48. The software application of claim 34, wherein the product packaging information includes a barcode.

49. The software application of claim 34, wherein the product packaging information includes a digital photograph of a mosaic of black and white rectangles.

50. The software application of claim 34, wherein the product packaging information includes a digital photograph of the product packaging.

51. The software application of claim 34, wherein the product packaging information includes an RFID embedded in a radio frequency signal emitted from the food product.

52. The software application of claim 34, wherein the computer program code for receiving product packaging information for the food product further comprises:
computer program code for generating a food product list on a graphical user interface of the portable device; and
computer program code for allowing a user to select an item on the food product list via the graphical user interface.

53. The software application of claim 34, wherein the computer program code for receiving product packaging information for the food product further comprises providing a text search field for user input via a keyboard.

54. A computer-implemented method for tracking nutritional information, the method comprising:
receiving a food product identification for a food product;
comparing the food product identification against a food product identification database;
retrieving food product information for the food product from the database;
adding at least part of the food product information for the food product to a user profile;
analyzing a nutritional profile of the user profile based the addition of the food product information for the food product; and
updating the user profile with results of the analyzing for tracking nutritional information for the user profile.

55. The method of claim 54, wherein the method is performed in a computer system including at least one memory and at least one processor.

56. The method of claim 55, wherein the receiving of the food product identification is performed by the computer system via a communication network.

57. The method of claim 56, wherein the food product identification was previously obtained at a remote location with a portable electronic device and transmitted to the computer system by the portable electronic device.

58. The method of claim 57, further comprising transmitting at least part of the updated user profile to the portable electronic device.

59. The method of claim 58, further comprising formatting the at least part of the updated user profile in a graphical display format compatible with the portable electronic device prior to the transmitting.

60. The method of claim 54, wherein the method is performed in a portable electronic device including at least one memory and at least one processor.

61. The method of claim 60, wherein the database is stored in the at least one memory of the portable electronic device.

62. The method of claim 61, further comprising:
requesting updates for the database via a communication network; and
receiving updates for the database via the communication network.

63. The method of claim 60, wherein at least part of the database is stored in the at least one memory of the portable electronic device.

64. The method of claim 61, wherein if during the comparing step the food product identification is not found in the at least part of the database stored in the portable electronic device, then the method further comprising:
sending the food product identification to a remote computer system via a communication network with a request to compare the food product identification with another part of the database at the remote computer system; and
receiving at the portable electronic device the retrieved food product information from the remote computer system via the communication network.

65. The method of claim 60, wherein the portable electronic device includes a display screen, a telephone device, and a camera device.

66. The method of claim 60, wherein the portable electronic device includes a display screen and an RFID reader device.

67. A method for tracking nutritional information comprising:
receiving at least one received electronic signal associated with at least one food product;
at least one computer processor associating the at least one received electronic signal with a unique food product identifier stored in at least one database;
the at least one computer processor associating the unique food product identifier with at least one nutritional information;
the at least one computer processor analyzing at least one nutritional profile of at least one user profile based the at least one nutritional information;
the at least one computer processor updating the at least one user profile with results of the analyzing for tracking the at least one nutritional information for the at least one user profile.

68. The method of claim 67, further comprising:
the at least one computer processor associating the updated at least one user profile with at least one transmit electronic signal; and
the at least one computer processor transmitting the at least one transmit electronic signal over a communication network.

69. The method of claim 67, wherein the target of the at least one computer processor transmitting the at least one transmit electronic signal over a communication network is a telephone device.

70. The method of claim 67, wherein the analyzing of the at least one nutritional profile of at least one user profile based the at least one nutritional information includes analyzing the at least one nutritional information and at least one user defined information.

71. The method of claim 67, further comprising disassociating at least part of the results of the analyzing for tracking the at least one nutritional information from the at least one user profile.

72. The method of claim 67, wherein all steps are performed within a same electronic device.

73. The method of claim 67, wherein the at least one received electronic signal is indicative of at least one RFID for the at least one food product.

74. The method of claim 67, wherein the at least one received electronic signal is indicative of at least one barcode for the at least one food product.

75. The method of claim 67, wherein the at least one received electronic signal is indicative of at least one digital photograph for the at least one food product.

76. The method of claim 67, wherein the at least one received electronic signal is received via the Internet.

77. The method of claim 67, wherein the at least one received electronic signal is received at least in part via a keyboard.

78. The method of claim 67, wherein the at least one received electronic signal is received at least in part via a mouse.

79. The method of claim 67, wherein the at least one received electronic signal is received at least in part via an optical finger navigation device.

80. The method of claim 67, wherein the at least one received electronic signal is received at least in part via at least one selection on a graphical user interface.

81. The method of claim 67, wherein the analyzing of the at least one nutritional profile of at least one user profile based the at least one nutritional information includes analyzing the at least one nutritional information and at least one dietary information.

82. The method of claim 67, wherein the analyzing of the at least one nutritional profile of at least one user profile based the at least one nutritional information includes at least one operation selected from a group of summing consumption, finding a mean consumption, finding a mode consumption, finding a median consumption, and finding a total consumption, finding a difference between daily consumption and recommended daily allowance, finding variance, and finding standard deviation.
